(19) United States
(12) Patent Application Publication
(10) Pub. No.: US 2008/0012991 A1
(43) Pub. Date: Jan. 17, 2008

(54) Device and method for processing object edges in digital video image

(75) Inventors: Yuan Wang, Beijing (CN); Song Qiu, Beijing (CN); David Xiaodong Yang, Beijing (CN); Qing Yu, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/777,906

(22) Filed: Jul. 13, 2007

(30) Foreign Application Priority Data
Jul. 13, 2006 (CN) 200610098849.2

(51) Int. Cl. H04N 5/21

(52) U.S. Cl. 348/625

(57) ABSTRACT

Device and method for processing object edges in digit video image are described. According to one aspect of the present invention, an edge detection operation is performed as follows: 1) calculating pixel difference flags for a plurality of slanted modes when performing interpolation of two rows in an interlaced video image or field; 2) calculating a weighted score for each slanted direction mode direction in step 1 using a target pixel as a center point; and 3) selecting one of the slanted directions by determining whether the object edge crossed the target pixel using the weighted scores in each slanted direction for the target pixel and the object edge angel resulting in one of interpolation schemes.

### BACKGROUND OF THE INVENTION

1. Field of the Invention

The present invention is related to the area of digital video processing, and more particularly related to processing object edges in digital videos.

2. Description of Related Art

Deinterlacing is a process of converting interlaced video (a sequence of fields) into a non-interlaced form (a sequence of frames). This is a fundamentally lossy process that always produces some image degradation, since it ideally requires “temporal interpolation” which involves guessing the movement of every object in the image and applying motion correction to every object. Field interpolation is used to process a whole field image or moving region, which is to generate pixels that are lost in the conversion. A simplest interpolation method is called vertical column averaging, namely averaging adjacent rows pixels in one field to produce a row of pixels that omitted in the interlaced video image. For each pixel, a vertical column interpolation scheme is applied. As a result, slanted object edges or lines become visible resulting in serious saw tooth distortion or stair distortion.

In order to solve this problem, several edge-adaptive interpolation (EAI) algorithms have been introduced. The basic principle is to detect whether there is any slanted object edge or line that crosses omitted pixels. If so, pixel interpolation is performed in the direction of the slanted edge or line; otherwise pixel interpolation is performed in a vertical direction. FIG. 1 shows a comparison between applying the vertical column average interpolation and applying EAI to an interlaced video image with a 45 degree slanted edge. Region 101 shows an image of 9-column by 7-row pixels. Region 102 shows an interlaced video image of 3-column by 2-row representing the 3×3 sub-region 101a (i.e., square box) in the region 101. In other words, the top (pixels a, b and c) and bottom (pixels d, e and f) rows of the region 102 are scanned and included in the interlaced image while the middle row of the region 102 is omitted pixels. De-interlacing process is to generate the omitted pixels from the scanned or existing pixels (e.g., interpolating the existing pixels). For example, pixel g (i.e., pixel with an “X”) in region 102 needs to be generated. Using the vertical column average interpolation, pixel g is generated by averaging the value of pixel b and pixel e (i.e., pixel b and pixel e are located in the vertical direction directly above and below pixel g). The result of apply vertical column average interpolation is shown in region 103. Region 104 is the result of using EAI, in which pixel c and pixel d are used to generate pixel g because pixel c and pixel d are located in slanted direction of the 45-deg edge. The region 103 shows stair distortion, while region 104 shows no distortion whatsoever.

An EAI algorithm kernel is configured to determine whether a slanted edge or line in an image and then determine the angle of the slanted direction. Using FIG. 1 as an example, the simplest 45 degree EAI includes calculating pixel differences in three different directions: 1) pixel b minus pixel e in the vertical direction, 2) pixel a minus pixel f in the left slanted 45 degree direction and 3) pixel c minus pixel d in the right slanted 45 degree. Then the direction with smallest absolute value is chosen as the object edge direction to generate the omitted pixel g. In this simple example, EAI algorithm is only applied using three different object edge directions. The EAI algorithm is actually much more complicated and can determine much more object edge directions. In addition, the EAI algorithm could make correction or adjustment to those pixels obvious different from neighboring pixels using a mean value filter. However, EAI has its problems and shortcomings: using small number of pixels to determine object edges results into low accuracy, which causes further problems as follows: 1) The smaller an angle of an object's slanted edge (i.e., angle between the slanted line and the horizontal line), the more difficult it is to detect and determine the slanted line correctly, especially for angles less than 10-deg., and 2) Most EAI algorithms cannot avoid raking angles, which is one of the reasons that it is difficult to detect low angle edges. In addition, when the mean value filter is used, it could destroy some of the correctly interpolated slanted edge pixels.

Hence, there would be a need for improved de-interlacing approaches in processing video image that includes object edges.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

According to one aspect of the present invention, an edge detection operation is performed as follows: 1) calculating pixel difference flags for a plurality of slanted modes when performing interpolation of two adjacent rows in an interlaced video image or field; 2) calculating a weighted score for each slanted direction mode direction in step 1 using a target pixel as a center point; and 3) selecting one of the slanted directions by determining whether the object edge crossed the target pixel using the weighted scores in each slanted direction for the target pixel and the object edge angel resulting in one of interpolation schemes.

With a chosen direction for calculating pixel difference and the interpolation scheme, a final interpolated image (i.e., de-interlaced image) can be obtained with the next two steps: obtaining the target pixel value by interpolating existing pixels using the selected direction for calculating pixel difference and the interpolation scheme; and finally checking the obtained target pixel to determine whether a bad point has been introduced by an incorrect interpolation; if so, erasing the bad point to further improve the quality of de-interlaced video image.

One of the objects, features, and advantages of the present invention is to provide methods and systems for better determination and detection of slanted object edge in processing of interlaced video image.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 shows results comparison between applying a vertical column average interpolation and applying an edge adaptive interpolation (EAI) to an interlaced video image;

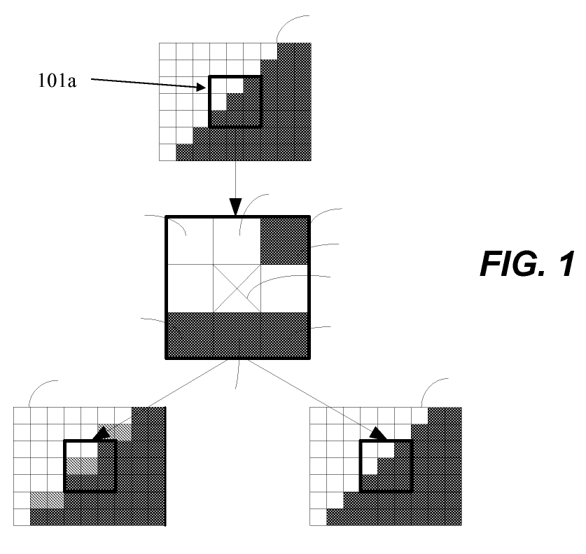

FIG. 2 is a schematic diagram showing a number of exemplary slanted direction modes used for generating omitted pixels of interlaced video image, according to an embodiment of the present invention;

FIG. 3 is a flowchart showing an exemplary process of performing edge adaptive interpolation of interlaced video images in accordance with one embodiment of the present invention;

FIG. 4 is a schematic diagram showing how a weighted score of a slanted direction mode (L1 mode) is calculated in accordance with one embodiment of the present invention;

FIG. 5 is a schematic diagram showing more details of FIG. 4;

FIG. 6 is a schematic diagram showing how a weighted score of a slanted direction mode (L2 mode) is calculated in accordance with one embodiment of the present invention;

FIG. 7 is a schematic diagram showing how a weighted score of a slanted direction mode (L3 mode) is calculated in accordance with one embodiment of the present invention;

FIG. 8 is a schematic diagram showing how a weighted score of a slanted direction mode (L4 mode) is calculated in accordance with one embodiment of the present invention;

FIG. 9 is a schematic diagram showing how a weighted score of a slanted direction mode (L6 mode) is calculated in accordance with one embodiment of the present invention;

FIG. 10 is a schematic diagram showing how a weighted score of a slanted direction mode (L7 mode) is calculated in accordance with one embodiment of the present invention;

FIG. 11 is a schematic diagram showing how a weighted score of a slanted direction mode (L8 mode) is calculated in accordance with one embodiment of the present invention;

FIG. 12 is a schematic diagram showing how a weighted score of a slanted direction mode (L9 mode) is calculated in accordance with one embodiment of the present invention;

FIG. 13 is a schematic diagram illustrating various interpolating schemes in accordance with one embodiment of the present invention; and

FIG. 14 is a structural block diagram showing salient components of an exemplary device for edgy detection using edgy-adaptive interpolation method in accordance with one embodiment of the present invention.

### DETAILED DESCRIPTION OF THE INVENTION

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or “an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments mutually exclusive of other embodiments. Further, the order of blocks in process, flowcharts or functional diagrams representing one or more embodiments do not inherently indicate any particular order nor imply limitations in the invention.

As used herein, the singular forms “a”, “an”, and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

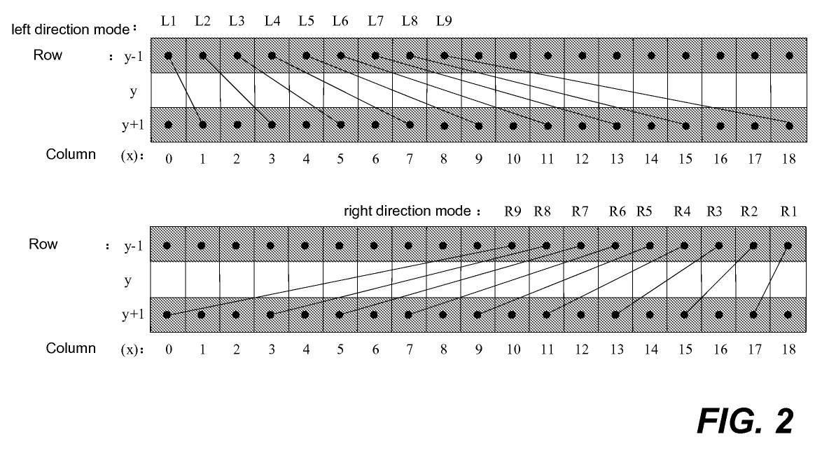

According to one exemplary embodiment of the present invention as shown in FIG. 2, 18 slanted direction modes (i.e., 18 different directions for calculating pixel difference) are chosen to determine each of omitted pixels in an interlaced video image. Including in the 18 slanted modes, there are 9 pairs of symmetric directions in mirror image orientation. Shaded (gray) squares refer to existing pixels located in row (y−1) and row (y+1), while non-shaded (white) boxes represent omitted pixels in row y. Ln (where n=1, 2, . . . , 9) are denoted as a left slanted direction modes, and Rn (where n=1, 2, . . . , 9) a right slanted direction modes. Rows and columns represent pixel position references or coordinates, which are used to define each of the slanted direction modes. In FIG. 2, only one direction line (slanted direction) is shown for each of the 18 slanted direction modes, in general, there are different numbers of slanted directions used for implementing the present invention. For example, each slanted direction mode scans whole row of pixels from left to right to calculate pixel difference column by column. If a width of a row (i.e., a field) is N pixels, then there are (N−1) L1 and R1 slanted direction modes, (N−2) L2 and R2 modes, and so on. Although 18 slanted direction modes are used in the embodiment as shown in FIG. 2, the number of slanted direction modes may be different, either more or less, to accomplish substantially similar objectives of the present invention.

In general, there are three components in a video signal, such as RGB or YCbCr, which means each pixel comprising three component values. The pixel value referred herein represents one of the components, such as a brightness component Y, a color component value Cr or Cb. To facilitate the description of the present invention, unless otherwise stated, the following description is based on the brightness component Y, as an example, the same shall be applicable to other two components.

According to one aspect of the present invention, an edge detection operation is performed as follows: 1) calculating pixel difference flags for a plurality of slanted modes when performing interpolation of two adjacent rows in an interlaced video image or field; 2) calculating a weighted score for each slanted direction mode direction in step 1 using a target pixel as a center point; and 3) selecting one of the slanted directions by determining whether the object edge crossed the target pixel using the weighted scores in each slanted direction for the target pixel and the object edge angel resulting in one of interpolation schemes.

With a chose direction for calculating pixel difference and the interpolation scheme, a final interpolated image (i.e., de-interlaced image) can be obtained with the next two steps: obtaining the target pixel value by interpolating existing pixels using the selected direction for calculating pixel difference and the interpolation scheme; and finally checking the obtained target pixel to determine whether a bad point has been introduced by an incorrect interpolation; if so, erasing the bad point to further improve the quality of de-interlaced video image.

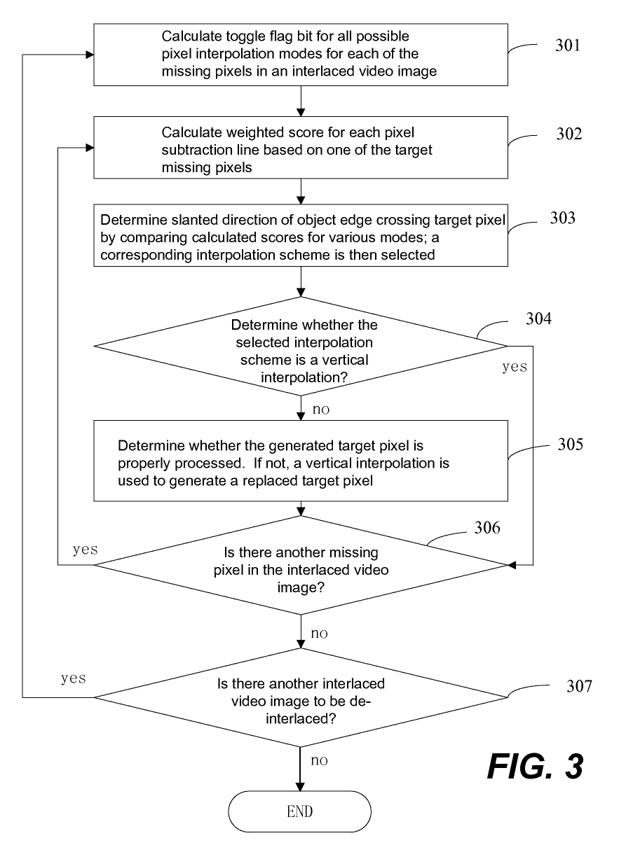

FIG. 3 is a flowchart showing process 300 of performing edge adaptive interpolation of interlaced video images in accordance with one embodiment of the present invention. Process 300 may be implemented in software, hardware or in a combination of both. The process 300 starts at 301, in which pixel difference flag for all of the slanted direction modes (i.e., directions for calculating pixel difference) are calculated for all of the omitted pixels in an interlaced video image.

Using the 18 slanted modes example of FIG. 2, for each n (n=1, 2, . . . , 9), the process 300 pre-defines an edgy-adaptive interpolation tolerance EAIT[n], wherein EAIT[n]=EAIT[Ln]=EAIT[Rn]. If each row has N pixels, for each of the Ln or Rn modes, the process 300 calculates (N-n) pixel differences. In other words, pixel difference for all possible modes of each omitted pixel is calculated. If the absolute value of the pixel difference is less than the edgy-adaptive interpolation tolerance EAIT[n], set a pixel difference flag to 1 for that slanted direction, otherwise 0. The pixel difference flag can then be used to reduce any further calculations by only using single bit operations.

Threshold value or tolerance EAIT[n] is used for determining whether two pixels in a particular slanted direction are the same or nearly the same. Absolute value of the pixel difference is used here to ensure the comparison is meaningful. Generally, pixel value is represented by an unsigned 4- to 16-bit number. The most commonly used pixel value is represented by an 8-bit integer whose value range is 0-255. When absolute value range of pixel difference is between 0 and 255, the tolerance EAIT[n] should be selected in the range between 16 and 64. The same ratio should be used when other sized integer is used for representing pixel value. For example, if pixel value is represented by one additional bit, then EAIT[n] range should be doubled. Or if pixel value is represented by one less bit, EAIT[n] range should be divided by 2. When the tolerance is set very tight, detecting object edge crossing the target pixel is more accurate. However, in the flip side, some real edge would be missed because of the tight tolerance. In addition, in the present invention, the tolerance may be set to a different value in different direction. If tolerance is set to different numbers, the slanted direction with smaller slanted angle should have a tighter tolerance, that is EAIT[1]≧EAIT[2]≧, . . . ≧, EAIT[9].

In an interlaced video image with each row including N pixels (i.e., ImageWidth), P(x,y) represents a pixel located in row x column y, where x and y starts from 0. Row y represents the omitted pixel row, row (y−1) and row (y+1) represent the existed pixel rows. Abs( ) means to the absolute value, EAIT[n] represents 9-pair of tolerances, Flag_Ln and Flag_Rn, n=1, 2, . . . , 9 means 9-pair of pixel difference flags, each for one of the 18 slanted modes. For each pixel in row y, pixel difference flag for the Ln mode is calculated by the following algorithm in pseudo-code:

| for (x = 0; x <= ImageWidth−n−1; x++) | |
|---|---|
| { | |
| diff = abs(P(x, y−1) − P(x+n, y+1)); | |
| if (diff < EAITHR[n]) | Flag_Ln[x] = 1; |
| else | Flag_Ln[x] = 0; |
| } | |

Pixel difference flag for the Rn mode is:

| for (x = n; x <= ImageWidth−1; x++) | |
|---|---|
| { | |
| diff = abs(P(x, y−1) − P(x−n, y+1)); | |
| if (diff < EAITHR[n]) | Flag_Rn[x] = 1; |
| else | Flag_Rn[x] = 0; |
| } | |

Next, at 302, the process 300 calculates a weighted score for each of the slanted direction modes using calculated pixel difference flags for one of the omitted pixels (i.e., target pixel). It is evident that those slanted direction modes with pixel difference flag set to zero are not required for any calculations.

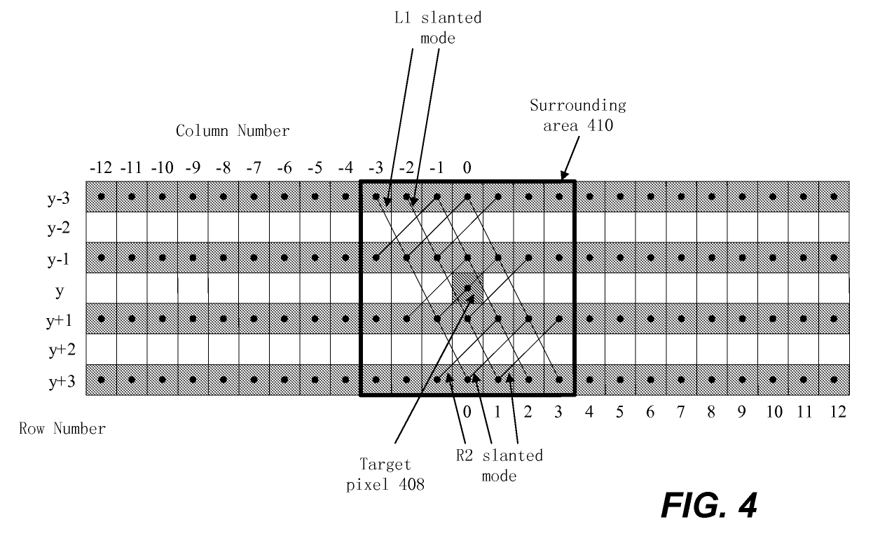

To demonstrate how a weighted score of an interpolation mode is calculated, the L1 slanted direction mode is used in an example as shown is FIG. 4 in accordance with one embodiment of the present invention. In FIG. 4, gray colored boxes represent to the existing pixels and white boxes represent omitted pixels in an interlaced video image. The target pixel 408 (i.e., one of the omitted pixels to be generated), P(x,y), is located in the middle of a surrounding area 410 (a box bordered by dark black lines), which is a 7-column by 4-row interlaced image (omitted pixels are included but not counted). The area 410 is chosen for the target pixel 408 as the surrounding area of influence. Although the area 410 includes 4 rows and 7 columns of pixels, the present invention does not set any limit as to number of rows or columns for the selection.

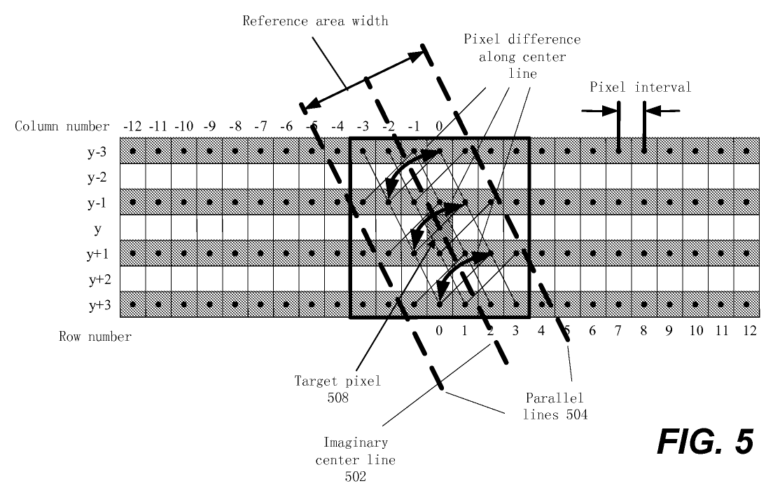

To further demonstrate how the weight score is calculated, FIG. 5 shows another schematic diagram in accordance with the present invention. As shown in FIG. 5, in order to de-interlace pixels in the direction of the L1 slanted line mode, an imaginary center line 502 crossing the target pixel 508 is created with a pair of parallel lines 504 that are located either side of the center line 502 with 1-3 pixel distance. The pair of the parallel lines 504 forms reference area with a width between 2-6 pixels. The example in FIG. 5 shows a nearly 4-pixel width reference area between the pair of parallel lines 504.

In order to include more relevant pixel information for generating the target pixel 508, one of the better interpolation schemes is to select the reference area including 4 pixel rows (2 above and 2 below the target pixel). To calculate the weight score using pixel difference flag of each pixel in the parallel direction of the L1 slanted direction, a set of positive weighting factors or coefficients is assigned. For the direction perpendicular or nearly perpendicular to the direction of the L1 slanted direction, and crossing the center line 502, a set of negative weight coefficients is assigned. In this example, these nearly perpendicular directions include R2, R3 and/or R4 modes. Other variations that comprise different size of the reference area may lead to different modes included in the calculation of weighted score.

As shown in FIG. 4, pixel difference flags for slanted lines parallel to the direction of the L1 mode and slanted lines perpendicular or nearly perpendicular to the direction of the L1 mode within the surrounding area 410. Omitted pixels located in three rows (y−2), y and (y+2) and intersected by the slanted lines of the L1 mode and R2 mode are selected. Using the L1 mode pixel difference flag and the R2 mode pixel difference flag with weighting coefficient, the process 300 calculate 3 scores in the L1 mode. Table 1 shows each of pixel weighting coefficients corresponding to the respective pixel difference flag.

TABLE 1

| | | | Weighting | Weighted | |
|---|---|---|---|---|---|
| | Flag | Sub-index i | coefficient | score | |
| sum1 | Flag_L1[x + i][y − 2] | −3, −2, −1, 0 | 1, 3, 3, 1 | 8 | 4 |
| | Flag_R2[x + i][y − 2] | −1, 0, 1 | −1, −2, −1 | −4 | |
| sum2 | Flag_L1[x + i][y] | −2, −1, 0, 1 | 3, 5, 5, 3 | 16 | 8 |
| | Flag_R2[x + i][y] | 0, 1, 2 | −2, −4, −2 | −8 | |
| sum3 | Flag_L1[x + i][y + 2] | −1, 0, 1, 2 | 1, 3, 3, 1 | 8 | 4 |
| | Flag_R2[x + i][y + 2] | 1, 2, 3 | −1, −2, −1 | −4 | |

| | |
|---|---|
| Total weighted | 16 |
| scores: | |

The mathematical equation for sum1 of Table 1 can be written as follows:

sum1=1×Flag_{—}L1[x−3][y−2]+3×Flag_{—}L1[x−2][y−2]

+3×Flag_{—}L1[x−1][y−2]+1×Flag_{—}L1[x][y−2]−1×Flag_{—}L1[x−1][y−2]

−2×Flag_{—}L1[x][y−2]−1×Flag_{—}L1[x+1][y−2]

Equations for sum2 and sum3 can be written similarly. Three distinct weighted scores, Score[1][0], Score[1][1], Score[1][2] in the L1 slanted direction mode are calculated as follows:

Score[1][0]=sum1+sum2+sum3

Score[1][1]=sum1+sum2

Score[1][2]=sum2+sum3

Score[1][0] is a weighted score of the summation of the three rows, while Score[1][1] and Score[1][2] are weighted scores of the sum of the upper 2 rows and the lower 2 rows, respectively. When the target pixel is located on the upper slant edge, row (y−2) pixel difference flag would not match edge character, under this condition, only Score[1][2] would represent object slant edge character; When target pixel is located on slant lower edge, only Score[1][1] would represent object slant edge character; Under other conditions, Score[1][0] is commonly used to represent object slant edge character, for Score [1][0] contain the most pixel information.

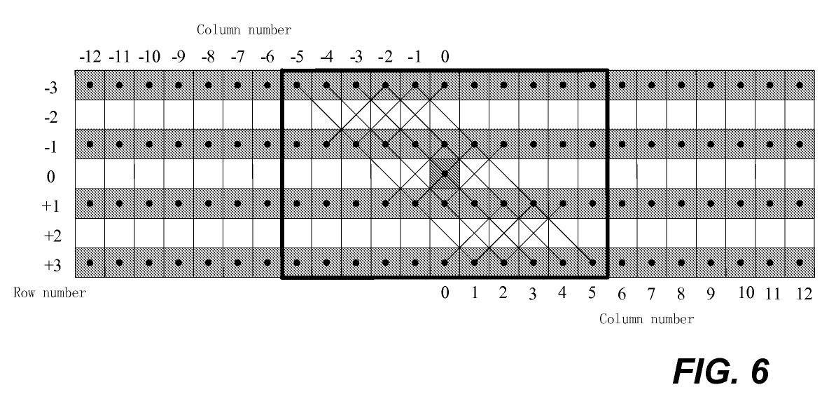

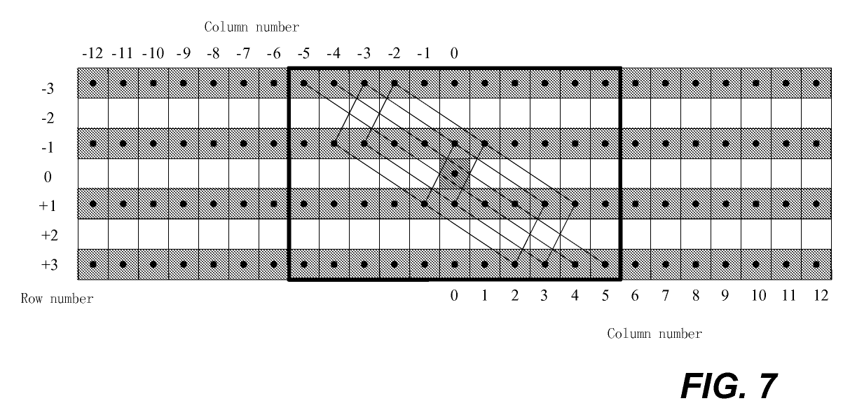

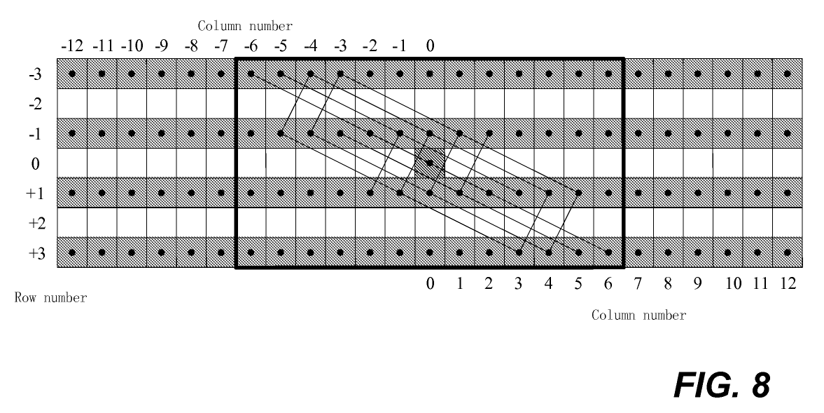

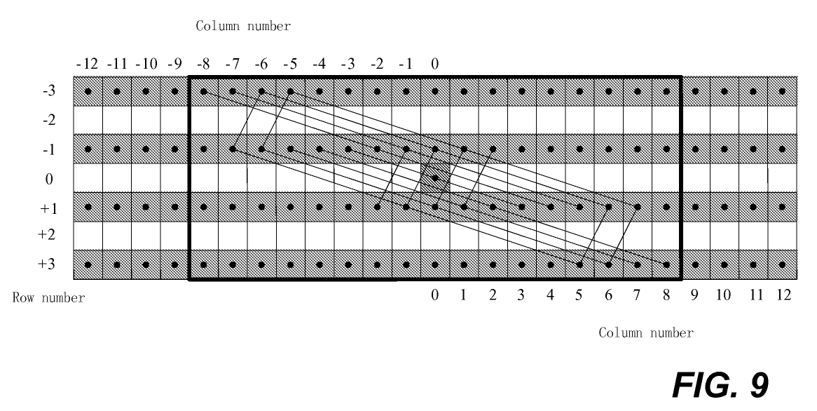

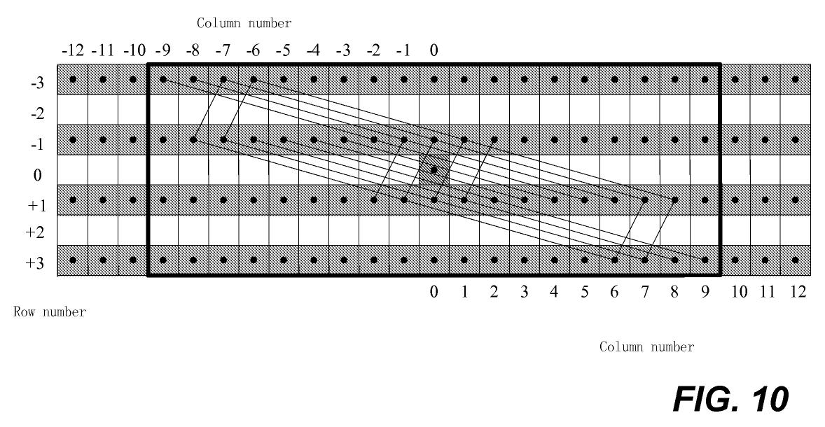

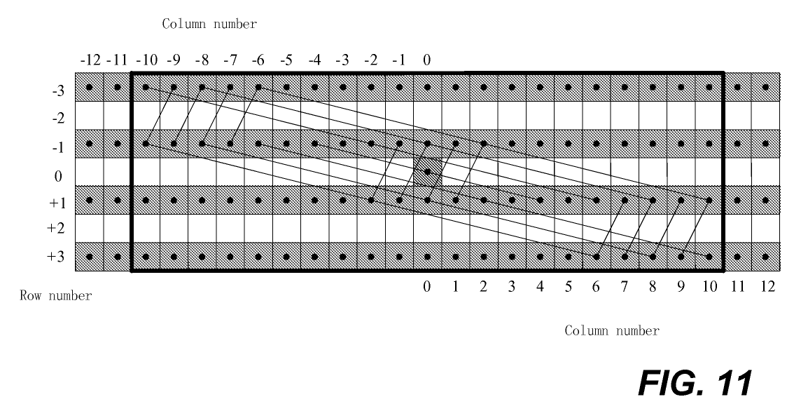

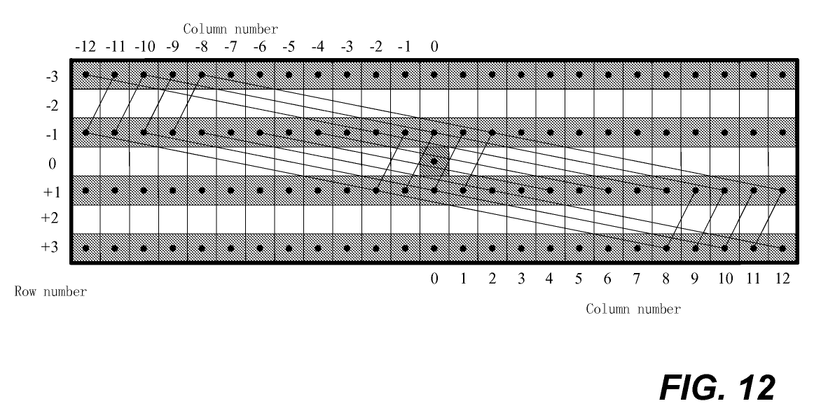

Using the method described above for the L1 slanted direction mode, weighted scores of all of the other modes can be calculated. Tables 2 to 9 list the weighted scores of the L2 to L9 modes, respectively. All weighted scores are calculated for 4 rows and M columns (omitted pixels to be generated are shown but not counted). FIGS. 6, 7, 8, 9, 10, 11 and 12 show respective schematic diagrams for the L2, L3, L4, L6, L7, L8 and L9 slanted direction modes. Based on the figures listed in Tables 2 to 9 and FIG. 4 to 12, all of the weighted scores can be calculated such as Score[2n−1][0], Score[2n−1][1] and Score[2n−1][2] in each direction, where n=2, 3, . . . , 9.

TABLE 2

| | | | Weighting | Weighted | |
|---|---|---|---|---|---|
| | Flag | Sub index i | coefficient | score | |
| sum1 | Flag_L2[x + i][y − 2] | −5, −4, . . . , | 1, 2, 2, 2, 1 | 8 | 4 |
| | | −1 | | | |
| | Flag_R2[x + i][y − 2] | −2, −1, 0 | −1, −2, −1 | −4 | |
| sum2 | Flag_L2[x + i][y] | −3, −2, . . . , 1 | 2, 4, 4, 4, 2 | 16 | 8 |
| | Flag_R2[x + i][y] | 0, 1, 2 | −2, −4, −2 | −8 | |
| sum3 | Flag_L2[x + i][y + 2] | −1, 0, . . . , 3 | 1, 2, 2, 2, 1 | 8 | 4 |
| | Flag_R2[x + i][y + 2] | 2, 3, 4 | −1, −2, −1 | −4 | |

| | |
|---|---|
| Total weighted | 16 |
| scores: | |

TABLE 3

| | | | Weighting | Weighted | |
|---|---|---|---|---|---|
| | Flag | Sub index i | coefficient | score | |
| sum1 | Flag_L3[x + i][y − 2] | −5, −4, −3, −2 | 2, 3, 2, 1 | 8 | 4 |
| | Flag_R1[x + i][y − 2] | −3, −2 | −2, −2 | −4 | |
| sum2 | Flag_L3[x + i][y] | −4, −3, . . . , 1 | 1, 3, 4, 4, | 16 | 8 |
| | | | 3, 1 | | |
| | Flag_R1[x + i][y] | 0, 1 | −4, −4 | −8 | |
| sum3 | Flag_L3[x + i][y + 2] | −1, 0, 1, 2 | 1, 2, 3, 2 | 8 | 4 |
| | Flag_R1[x + i][y + 2] | 3, 4 | −2, −2 | −4 | |

| | |
|---|---|
| Total weighted | 16 |
| scores: | |

TABLE 4

| | | | Weighting | Weighted | |
|---|---|---|---|---|---|
| | Flag | Sub index i | coefficient | score | |
| sum1 | Flag_L4[x + i][y − 2] | −6, −5, −4, −3 | 2, 2, 2, 2 | 8 | 4 |
| | Flag_R1[x + i][y − 2] | −4, −3 | −2, −2 | −4 | |
| sum2 | Flag_L4[x + i][y] | −5, −4, . . . , 1 | 1, 2, 3, 4, | 16 | 8 |
| | | | 3, 2, 1 | | |
| | Flag_R1[x + i][y] | −1, 0, 1, 2 | −1, −3, | −8 | |
| | | | −3, −1 | | |
| sum3 | Flag_L4[x + i][y + 2] | −1, 0, 1, 2 | 2, 2, 2, 2 | 8 | 4 |
| | Flag_R1[x + i][y + 2] | 4, 5 | −2, −2 | −4 | |

| | |
|---|---|
| Total weighted | 16 |
| scores: | |

TABLE 5

| | | | Weighting | Weighted | |
|---|---|---|---|---|---|
| | Flag | Sub index i | coefficient | score | |
| sum1 | Flag_L5[x + i][y − 2] | −7, −6, −5, −4 | 1, 1, 2, 2 | 6 | 2 |
| | Flag_R1[x + i][y − 2] | −5, −4 | −2, −2 | −4 | |
| sum2 | Flag_L5[x + i][y] | −6, −5, . . . , 1 | 1, 2, 3, 4, | 20 | 12 |
| | | | 4, 3, 2, 1 | | |
| | Flag_R1[x + i][y] | −1, 0, 1, 2 | −1, −3, −3, | −8 | |
| | | | −1 | | |
| sum3 | Flag_L5[x + i][y + 2] | −1, 0, 1, 2 | 2, 2, 1, 1 | 6 | 2 |
| | Flag_R1[x + i][y + 2] | 4, 5 | −2, −2 | −4 | |

| | |
|---|---|
| Total weighted | 16 |
| scores: | |

TABLE 6

| | | | Weighting | Weighted | |
|---|---|---|---|---|---|
| | Flag | Sub index i | coefficient | score | |
| sum1 | Flag_L6[x + i][y − 2] | −8, −7, −6, −5 | 1, 2, 2, 1 | 6 | 2 |
| | Flag_R1[x + i][y − 2] | −5, −4 | −2, −2 | −4 | |
| sum2 | Flag_L6[x + i][y] | −7, −5, . . . , 1 | 1, 2, 2, 3, 4, | 20 | 12 |
| | | | 3, 2, 2, 1 | | |
| | Flag_R1[x + i][y] | −1, 0, 1, 2 | −1, −3, −3, | −8 | |
| | | | −1 | | |
| sum3 | Flag_L6[x + i][y + 2] | −1, 0, 1, 2 | 1, 2, 2, 1 | 6 | 2 |
| | Flag_R1[x + i][y + 2] | 6, 7 | −2, −2 | −4 | |

| | |
|---|---|
| Total weighted | 16 |
| scores: | |

TABLE 7

| | | | Weighting | Weighted | |
|---|---|---|---|---|---|
| | Flag | Sub index i | coefficient | score | |
| sum1 | Flag_L7[x + i][y − 2] | −8, −7, −6, −5 | 2, 2, 1, 1 | 6 | 2 |
| | Flag_R1[x + i][y − 2] | −7, −6 | −2, −2 | −4 | |
| sum2 | Flag_L7[x + i][y] | −8, −5, . . . , 1 | 1, 1, 2, 3, 3, | 20 | 12 |
| | | | 3, 3, 2, 1, 1 | | |
| | Flag_R1[x + i][y] | −1, 0, 1, 2 | −1, −3, −3, | −8 | |
| | | | −1 | | |
| sum3 | Flag_L7[x + i][y + 2] | −1, 0, 1, 2 | 1, 1, 2, 2 | 6 | 2 |
| | Flag_R1[x + i][y + 2] | 7, 8 | −2, −2 | −4 | |

| | |
|---|---|
| Total weighted | 16 |
| scores: | |

TABLE 8

| | | | Weighting | Weighted | |
|---|---|---|---|---|---|
| | Flag | Sub index i | coefficient | score | |
| sum1 | Flag_L8[x + i][y − 2] | −10, −8, −6 | 2, 2, 2 | 6 | 0 |
| | Flag_R1[x + i][y − 2] | −9, −8, −7, −6 | −1, −2, −2, | −6 | |
| | | | −1 | | |
| sum2 | Flag_L8[x + i][y] | −10, −8, . . . , | 1, 3, 4, 4, | 20 | 12 |
| | | 2 | 4, 3, 1 | | |
| | Flag_R1[x + i][y] | −1, 0, 1, 2 | −1, −3, −3, | −8 | |
| | | | −1 | | |
| sum3 | Flag_L8[x + i][y + 2] | −2, 0, 2 | 2, 2, 2 | 6 | 0 |
| | Flag_R1[x + i][y + 2] | 7, 8, 9, 10 | −1, −2, −2, | −6 | |
| | | | −1 | | |

| | |
|---|---|
| Total weighted | 12 |
| scores: | |

TABLE 9

| | | | Weighting | Weighted | |
|---|---|---|---|---|---|
| | Flag | Sub index i | coefficient | score | |
| sum1 | Flag_L9[x + i][y − 2] | −12, −10, −8 | 2, 2, 2 | 6 | 0 |
| | Flag_R1[x + i][y − 2] | −11, −10, | −1, −2, −2, | −6 | |
| | | −9, −8 | −1 | | |
| sum2 | Flag_L9[x + i][y] | −12, −10, . . . , | 1, 2, 3, 4, | 20 | 12 |
| | | 2 | 4, 3, 2, 1 | | |
| | Flag_R1[x + i][y] | −1, 0, 1, 2 | −1, −3, −3, | −8 | |
| | | | −1 | | |
| sum3 | Flag_L9[x + i][y + 2] | −2, 0, 2 | 2, 2, 2 | 6 | 0 |
| | Flag_R1[x + i][y + 2] | 7, 8, 9, 10 | −1, −2, −2, | −6 | |
| | | | −1 | | |

| | |
|---|---|
| Total weighted | 12 |
| scores: | |

From the data of Table 1 to Table 9, the following regularities are observed:
A. sign of weighting coefficient: the present mode direction weighting coefficient is positive and the perpendicular or nearly perpendicular mode direction weighting coefficient is negative; wherein the negative weighting coefficient is used to avoid rake angles.
B. absolute value of the weighting coefficient: if some of the weighting coefficient is too large relative to others, the small weighting coefficients produce no influence; therefore, the absolute value of the weighting coefficient should be limited to less than 10.
C. each mode's total weighted score should be equal or approximately equal; when slanted angle reduces, the two pixels involved in the pixel difference calculation are spaced afar, which leads to inaccuracy, especially when slanted angle is less than 20 degree, therefore, the total weighted scores should be reduced to increase the accuracy. In one embodiment, the reduction of the total weighted score should be less than ⅛ of the weighted score range. For example, whereas the total weighted scores in Table 1 to Table 7 are all 16, the weighted score range is 48 (i.e., −16 to 32); therefore, the reduction of the total weighted scores is less or equal 6. As a result, the total weighted scores are reduced by 4 to 12 in Table 8 and Table 9.

### Since the corresponding Ln and Rn modes are symmetric (i.e., mirror image), the total weighted scores for each of the Rn modes can easily be obtained using the numbers for the Ln modes by exchanging the locations of the symmetric pixels.

Referring back to FIG. 3, the process 300 moves to 303. The process 300 compares the total weighted scores for all of the slanted modes to determine object edge direction and then an interpolation scheme. The detailed process is to pre-define 3 absolute edge scores (AES), AES[0], AES[1] and AES[2], and 3 relative edge scores (RES), RES[0], RES[1] and RES[2], then make following determination operations:

303a) choose a largest score Score[kₘₐₓ][0] from 18 scores, Score[k][0] (k=1, 2, . . . , 18), and determine whether Score[kₘₐₓ][0] is larger than AES[0], if true, the process 300 performs operation 303b, otherwise performs operation 303c.
303b) if the slanted direction mode of Score[kₘₐₓ][0] is left slanted direction mode (i.e., one of the Ln modes), then determine whether Score[kₘₐₓ][0] and all of the right slant mode weighted scores Score[2n][0](n=1, 2, . . . , 9) are larger than RES[0]. If true, mode direction of Score[kₘₐₓ][0] is the object edge where target pixel is located, choose this interpolation scheme. Otherwise choose vertical column interpolation scheme. The process 300 finishes the operation at 303 at this point.
Similarly, if the slanted direction mode of Score[kₘₐₓ][0] is one of the Rn modes, then determine whether Score[kₘₐₓ][0] and all of the left slant mode weighted scores Score[2n−1][0](n=1, 2, . . . , 9) are larger than RES[0]. If true, mode direction of Score[kₘₐₓ][0] is the object edge where target pixel is located, choose this interpolation direction scheme. Otherwise choose vertical column interpolation scheme. The process 300 finishes operation 303 at this point.
303c) select a largest score, Score[kₘₐₓ][1] from 18 scores, Score[k][1] (k=1, 2, . . . , 18), and determine whether Score[kₘₐₓ][1] is larger than AES[1]. If true, the process 300 moves to operation 303d, otherwise operation 303e.
303d) if the slanted direction mode of Score[kₘₐₓ][1] is one of the Ln modes, then determine if Score[kₘₐₓ][1] and all of the left slant mode scores Score[2n][1](n=1, 2, . . . , 9) are larger than RES[1]. If true, corresponding mode direction of Score[kₘₐₓ][1] is the object edge direction where target pixel is located, choose this interpolation scheme. Otherwise choose vertical column interpolation scheme. The process 300 finishes operation 303 at this point;
If slanted direction mode of Score[kₘₐₓ][1] is one of the Rn modes, then determine if Score[kₘₐₓ][1] and all of left slanted mode scores Score[2n−1][1](n=1, 2, . . . , 9) are larger than RES[1]. If true, corresponding mode direction of Score[kₘₐₓ][1] is the object edge direction where target pixel is located, choose this interpolation direction scheme. Otherwise choose vertical column interpolation scheme. The process 300 finishes operation 303 at this point.
303e) select a largest score, Score[kₘₐₓ][2] from 18 scores, Score[k][2] (k=1, 2, . . . , 18), and determine if a) Score[kₘₐₓ][2] is larger than AES[2]; and b) one of the Ln/Rn modes of Score[kₘₐₓ][2], Score[kₘₐₓ][2] and corresponding 9 scores of Rn/Ln (n=1, 2, . . . , 9) are larger than RES[2]. If true, Score[kₘₐₓ][2] is the object edge where target pixel is located, choose this interpolation scheme. Otherwise choose vertical column interpolation scheme. The process 300 finishes operation 303 at this point.

Score[k][1] and Score[k][2] are symmetric to each other, therefore AES[1]=AES[2], RES[1]=RES[2]. All the operations above, when Score[kₘₐₓ][0] is less than or equal to AES[0], Score[k][1] and Score[k][2] determination sequence can be exchanged, that is to determine Score[k][2] first. When Score[kₘₐₓ][2] is less than or equal to AES[2], Score[k][1] is then determined.

AES[0], AES[1] and AES[2] have a range of about 50% to 75% of the upper limit, which is the most likely value among Score[k][0], Score[k][1] and Score[k][2]. In other words, the most likely value when positive weighting coefficient having flag equal to 1 and negative weighting coefficient with flag equal to 0 in Tables 1 to 9. AES[0] has a practical range of 16 to 24 with an upper limit 32. AES[1] and AES[2], by only calculating upper two rows or lower two rows weighting coefficients, have an upper limit of 24 in Tables 1-4 and 26 in Tables 5-9, hence 25 is chosen as the upper limit. The range is between 12 and 19 accordingly. RES[0], RES[1] and RES[2] should use 25% to 50% of the upper limit as their range. Hence, AES[0] has a range of 8 to 16 with an upper limit 32; AES[1] and AES[2]: (by only calculating upper two rows or lower two rows weighting coefficients), the upper limit is 24 in Tables 1 to 4 and 26 in Tables 5 to 9, the corresponding range is 6 to 12; Higher AES and RES values result into a stricter edge determination, which means to reduce edge determination sensitivity and raise the edge determination accuracy.

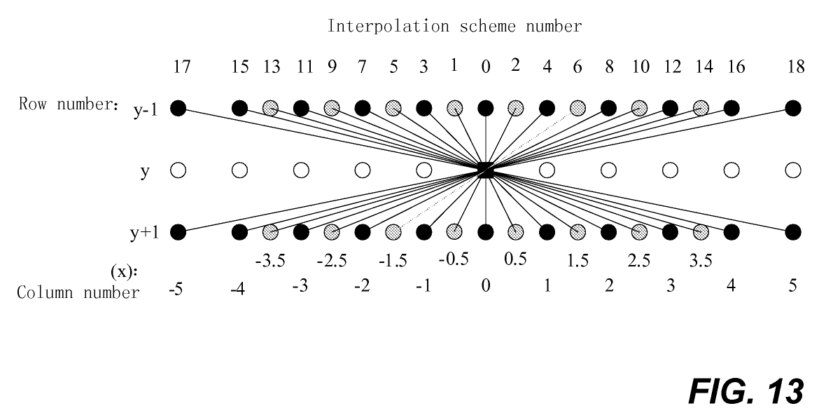

There are 19 interpolation schemes including one vertical direction and 18 slanted directions interpolation schemes, FIG. 13 is a schematic diagram illustrating the 19 pixel interpolation schemes, where black circles represent existing pixels located on those columns with integer coordinates in row (y−1) or row (y+1) while gray circles represent virtual pixels with non-integer coordinates. The virtual pixels are generated by interpolating the existing pixels located on the same row. Hollow circles represent omitted pixels in row y. The black square represents the target pixel in the middle of row y. Each of the 19 interpolation schemes is shown as a line connecting a pair of pixels through the target pixel. One of the pair of pixels is located in row (y−1), the other in row (y+1). Table 10 lists the mathematical formula used in each of the 19 interpolation scheme, where interpolation scheme number corresponds to the sequence number in FIG. 13.

TABLE 10

| Interpolation | |
|---|---|
| scheme number | Target pixel P(x, y) calculation formula |
| 0 | (P(x, y − 1) + P(x, y + 1))/2 |
| 1 | (P(x − 1, y − 1) + P(x, y − 1) + P(x, y + 1) + |
| | P(x + 1, y + 1))/4 |
| 2 | (P(x + 1, y − 1) + P(x, y − 1) + P(x, y + 1) + |
| | P(x − 1, y + 1))/4 |
| 3 | (P(x − 1, y − 1) + P(x + 1, y + 1))/2 |
| 4 | (P(x + 1, y − 1) + P(x − 1, y + 1))/2 |
| 5 | (P(x − 2, y − 1) + P(x − 1, y − 1) + |
| | P(x + 1, y + 1) + P(x + 2, y + 1))/4 |
| 6 | (P(x + 2, y − 1) + P(x + 1, y − 1) + |
| | P(x − 1, y + 1) + P(x − 2, y + 1))/4 |
| 7 | (P(x − 2, y − 1) + P(x + 2, y + 1))/2 |
| 8 | (P(x + 2, y − 1) + P(x − 2, y + 1))/2 |
| 9 | (P(x − 3, y − 1) + P(x − 2, y − 1) + |
| | P(x + 2, y + 1) + P(x + 3, y + 1))/4 |
| 10 | (P(x + 3, y − 1) + P(x + 2, y − 1) + |
| | P(x − 2, y + 1) + P(x − 3, y + 1))/4 |
| 11 | (P(x − 3, y − 1) + P(x + 3, y + 1))/2 |
| 12 | (P(x + 3, y − 1) + P(x − 3, y + 1))/2 |
| 13 | (P(x − 4, y − 1) + P(x − 3, y − 1) + |
| | P(x + 3, y + 1) + P(x + 4, y + 1))/4 |
| 14 | (P(x + 4, y − 1) + P(x + 3, y − 1) + |
| | P(x − 3, y + 1) + P(x − 4, y + 1))/4 |
| 15 | (P(x − 4, y − 1) + P(x + 4, y + 1))/2 |
| 16 | (P(x + 4, y − 1) + P(x − 4, y + 1))/2 |
| 17 | (P(x − 5, y − 1) + P(x + 5, y + 1))/2 |
| 18 | (P(x + 5, y − 1) + P(x − 5, y + 1))/2 |

After the direction of the object edge been determined and the interpolation scheme has been selected, the process 300 moves to decision 304 to generate the target pixel using the selected interpolation scheme. The process 300 determines whether the selected interpolation scheme is an interpolation in the vertical direction of the target pixel (i.e., the same column). If yes, the process 300 moves to 306, otherwise the process 300 follows the “no” branch to 305.

At 305 the process 300 determines whether the generated target pixel value is within the range of the pair of upper and lower row pixels in the same column. If true, do nothing. Otherwise interpolate the vertical pair of upper and lower pixels to obtain the target pixel value.

In certain complex scenery field, incorrect determination is hard to avoid. The resulting bad point in a slanted direction is so much different from the surrounding pixels, which leads to image quality. The objective of 305 is to keep properly generated target pixel while the bad point is corrected with a corrective action.

For example, the process 300 determines which one of the vertical pair of pixels, P(x,y−1) and P(x,y+1) is larger. The larger value is set as P_max and the other set as P_min. A range tolerance, POST_RANGE, is set to a value larger or equal to 0. If target pixel value is larger than (P_max+POST_RANGE) or less than (P_min-POST_RANGE), the target pixel is a bad point and needs to be replaced by vertical column interpolation scheme as (P(x,y−1)+P(x,y+1))/2. Otherwise the generated target pixel value is good and should be kept. A smaller POST_RANGE leads to more corrections and it may even make corrections to properly generated or interpolated target pixels. Therefore, POST_RANGE needs to be selected properly. If pixel value is represented by an 8-bit integer, the POST_RANGE should be between 0 and 64.

Next at decision 306, the process 300 determines whether there is another target pixel in the field. If true, the process 300 moves back to 302, otherwise the process 300 moves to another decision 307.

At 307, the process 300 sends out a de-interlaced image from the interlaced video image, then determines if there is another interlaced video image to be processed. If true, the process 300 moves back to 301, otherwise the process 300 ends.

In an alternative embodiment, for each n modes (n=1, 2 . . . , 9) at 301, the process 300 may set several threshold EAIT[n]₁, EAIT[n]₂, . . . , EAIT[n]ₘ, where m is larger than 1, the pixel difference flag width needs to be increased to cover larger number. For example, whereas three tolerances are set as follows: EAIT[n]₁<EAIT[n]₂<EAIT[n]₃, the pixel difference flag width needs to be 2-bit. If the absolute value of the pixel difference<EAIT[n]₁, the corresponding pixel difference flag is set to 3. If EAIT[n]₁≦the absolute value of the pixel difference<EAIT[n]₂, then pixel difference flag is 2. If EAIT[n]₂≦the absolute value of pixel difference<EAIT[n]₃, the pixel difference flag is 1; if the absolute value of pixel difference≧EAIT[n]₃, the pixel difference flag is set to 0. Although pixel difference flag storage space is twice as original, it is much less than the space to store pixel itself. More importantly, pixel difference flag can distinguish more delicately of pixel difference information. Weighted scores for the object edge can be much differentiated from other scores, which help to detect object edge direction correctly and reduce mistakes.

Due to the increase of pixel difference flag value, the range of weighted scores for each direction will be increased. For example, if bit width were increased from 1-bit to 2-bit, the range of the weighted scores would increase to 3 times of the original value to 144 (from −48 to 96). AES[0], AES[1] and AES[2] and RES[0], RES[1] and RES[2] are also increased to 3 times of the original values. Accordingly, the ratio between weighting coefficients for small slanted angle directions and for the large slanted angle directions should not be reduced by more than 18=144/8.

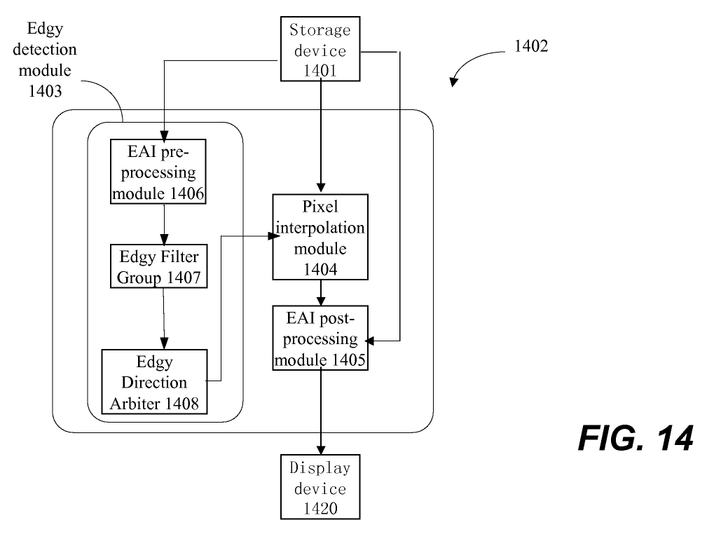

Referring now to FIG. 14, which shows an exemplary edge-adaptive interpolation device 1402 in accordance with one embodiment of the present invention. The device 1402 is coupled to a storage device 1401 configured for storing digital video images (e.g., scanned interlaced image), and coupled to a video display configured to display de-interlaced video image.

The device 1402 comprises an edge detection module 1403, a pixel interpolation module 1404, and an EAI post-processing module 1405. The edgy detection module 1403 is configured for performing edge detection of a target pixel in an interlaced video image received from the digital video storage 1401. The edgy detection module 1403 is also configured for determining the direction of object edge at target pixel, and for selecting most appropriate interpolation scheme based on the determined direction. The selected interpolation scheme information is passed to the pixel interpolation module 1404.

The pixel interpolation module 1404 is configured to generate target pixels by interpolating existing pixels using the selected interpolation scheme and to form a de-interlaced video image. The de-interlaced image is sent to the EAI post-processing module 1405, which is configured to determine whether each generated target pixel is properly processed based on one or more pre-defined tolerance. If necessary, improperly interpolated target pixel (i.e., bad point) is replaced with a vertical column interpolation scheme.

The edge detection module 1403 further comprises an EAI pre-processing module 1406, an edge filter group 1407 and an edgy direction arbiter 1408. the EAI pre-processing module 1406 is configured for storing pre-determined slanted direction mode Ln/Rn and tolerances EAIT[n]₁ to EAIT[n]m for each of n pixels in a row of omitted pixels, where m and n are integer and greater than or equal to 1; for calculating every slanted direction mode pixel difference of the pre-determined slanted direction mode; for storing pixel difference flag by comparing absolute value of pixel differences and tolerance EAIT[n]m; and for sending out all of the pixel difference flags of the interlaced video image to the edge filter group 1407.

The edge filter group 1407 comprises K (K=2n+1) pairs of structural symmetry edge filters. Each of the edge filters corresponds to one slanted direction mode (Ln/Rn). Function of the edge filter is to select 3 rows of pixel difference flag in a 4-row by N-column area centered by the target pixel. The pixel difference flags are divided into two groups: one is to follow the slanted direction mode, the other is perpendicular or nearly perpendicular to the slanted direction mode. The edge filter group 1407 is also configured to assign a weighting coefficient for each selected pixel difference flag. The value of the weighting coefficient is larger when the location of the existing pixel is closer to the target pixel. The weighting coefficients in the parallel direction are positive, negative in perpendicular or nearly perpendicular direction. The weighted scores of each slanted direction mode is equal or nearly equal. The edge filer calculates the selected 3 rows pixel difference flag weighted scores including the total of the three rows, two upper rows pixel and two lower rows. Finally the edge filter group 1407 is configured to sending out 3K weighted scores for 1 K pairs of edge filters to edge direction arbiter 1408.

The edge direction arbiter 1408 is configured for determining whether slanted edge is passing through the target pixel and the edge direction based on the received weighted scores from the edge filter group 1407. The edge direction arbiter 1408 is also configured for determining which one of the interpolation schemes to use. That information (i.e., serial number of the interpolation scheme) is sent to the pixel interpolation module 1404.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A device for processing object edges in digital video image, the device comprising:
an edge detection module configured for selecting an interpolation scheme for generating omitted pixels in a received interlaced video image;
a pixel interpolation module coupled to the edge detection module, configured for generating a target pixel using the selected interpolation scheme using existing pixels in two rows of the target pixel; and
a post-processing module coupled to the pixel interpolation module, configured for determining whether the generated target pixel is properly interpolated within a region surrounding the target pixel, and configured for replacing improperly generated target pixel.

2. The device of claim 1, wherein the edge detection module further comprising:
a pre-processing module configured for pre-calculating a pixel difference and assigning a pixel difference flag for each of the plurality of slanted line modes;
a plurality of edge filers coupled to the pre-processing module, configured for calculating a set of weighted scores for each of the selected slanted line modes in a reference area centering the target pixel; and
an edge direction arbiter coupled to the edge filters, configured for determining whether one of the object edges actually passes through the target pixel at a particular one of the slanted line modes using the weighted scores.

3. The device of claim 2, wherein the plurality of slanted line modes comprises N pairs of different slanted directions with each pair orients in a mirror image, where N is a positive integer.

4. The device of claim 2, wherein said assigning the pixel difference flag is achieved by comparing absolute value of pixel difference with a predefined tolerance for each of the slanted line modes.

5. The device of claim 2, wherein the reference area has an imaginary center line parallel to one of the slanted line modes.

6. The device of claim 1, wherein the target pixel is one of the omitted pixels.

7. The device of claim 1, wherein said replacing the improperly generated target pixel is achieved by a vertical column interpolation scheme.

8. A method for processing object edges in digital video image, the method comprising:
(a) receiving an interlaced video image have a plurality of omitted pixels;
(b) assigning value to each of a plurality of pixel difference flags, one flag for each of a plurality of slanted line mode directions;
(c) calculating a set of weighted scores for each of a set of selected directions within a reference area centering around a target pixel, wherein the target pixel is one of the omitted pixels;
(d) determining which one of the object edges passes through the target pixel at an angle corresponding to one of the slanted line modes and then selecting a corresponding one of a plurality of interpolation schemes; and
(e) generating the target pixel using the selected interpolation scheme;
(f) repeating (b)-(e) until all of the omitted pixels have been generated thereby the interlaced video image has been de-interlaced.

9. The method of claim 8, said assigning value to each of a plurality of pixel difference flags further comprising:
pre-defining a plurality of tolerances, one for each of the slanted line mode directions;
calculating a plurality of pixel differences, one for each of the slanted line mode directions; and
comparing absolute value of the pixel difference to the corresponding tolerance to determine the value of the flags.

10. The method of claim 8, wherein the reference area has an imaginary center line parallel to one of the slanted line modes and through the target pixel.

11. The method of claim 10, wherein the set of weighted scores is calculated using the pixel difference flags of omitted pixels in three different rows located within the reference area.

12. The method of claim 11, wherein each of the pixel difference flags is associated with a weighting coefficient such that pixels closer to the imaginary center line get higher influence.

13. The method of claim 8, wherein the angle corresponding to one of the slanted line modes decreases is unique for each of the modes.

14. The method of claim 8, further comprising:
performing a comparison between the value of the generated target pixel and a representative value of other surrounding pixels; and
replacing the generated target pixel using a vertical column interpolation scheme, if the comparison shows a larger than acceptable limit.

15. The method of claim 14, wherein the representative value is mean value.

16. The method of claim 14, wherein the acceptable limit is defined by a user.
